(19) United States
(12) Patent Application Publication
(10) Pub. No.: US 2018/0109537 A1
(43) Pub. Date: Apr. 19, 2018

(54) ASSIGNING A LEVEL OF TRUST BETWEEN ENTITIES IN AN ONLINE SYSTEM FOR DETERMING WHETHER TO PERMIT AN ACTION REQUESTED BY AN ENTITY

(71) Applicant: Facebook, Inc., Menlo Park, CA (US)

(72) Inventors: Nathan Gaston Schmidt, San Francisco, CA (US); Mark Ford Westling, Menlo Park, CA (US); Aparna Nemana, Sunnyvale, CA (US)

(21) Appl. No.: 15/296,426

(22) Filed: Oct. 18, 2016

(51) Int. Cl. H04L 29/06; G06Q 30/02; G06Q 50/00

(52) U.S. Cl. CPC H04L 63/105; G06Q 30/0214; H04L 67/306; G06Q 50/01; G06Q 30/0255

(57) ABSTRACT

An online system assigns a level of trust between a requesting entity and a target entity based on connections between users of the online system associated with the requesting entity and users of the online system associated with the target entity in response to receiving a request from the requesting entity to perform an action that is directed towards the target entity. If the assigned level of trust exceeds a threshold level of trust, the online system permits the requesting entity to perform the action; otherwise, the online system denies the request. The level of trust between the entities may be used by the online system to determine whether to grant or deny additional types of requests received from the requesting entity (e.g., a request to create an advertising account to purchase advertising services provided by the online system).

### BACKGROUND

This disclosure relates generally to online systems, and more specifically to assigning a level of trust between entities in an online system used to determine whether to permit an action requested by an entity.

An online system allows its users to connect and communicate with other online system users. Users create profiles in the online system that are tied to their identities and include information about the users, such as interests and demographic information. The users may be individuals or entities such as corporations or charities. Because of the popularity of online systems and the ease with which users of the online systems may interact with each other, an online system provides an ideal forum for users to perform actions in the online system that may be directed towards additional users of the online system. For example, a user may share content with additional users of the online system by initiating messages that include text, photos, and other types of content that are sent to the additional users.

Conventionally, online systems allow entities to create user profiles so that the entities may establish a presence in the online systems to connect and exchange content with other users of the online systems. By creating user profiles, entities may post information about themselves, their products, or their services via a brand page associated with the entity's user profile. Other users may then establish connections with the entity to receive information from the brand page. Additionally, users who are associated with an entity may establish connections with the entity in an online system. For example, connections may be established between a business entity and users of an online system who are employees of the business entity.

Similar to individual users, entities may perform actions in an online system that are directed towards additional users of the online system. For example, an entity may initiate messages that include advertisements that are directed towards users to allow the entity to gain public attention for products or services and to persuade online system users to take an action regarding the entity's products, services, opinions, or causes. Although individual users of the online system may be interested in such messages, entities usually establish a presence in an online system in order to promote their own products or services and are often not interested in receiving advertisements and other types of spam from other entities. Therefore, entities may ignore messages or other types of actions directed towards them from other entities. However, doing so may cause important messages and other types of actions directed towards an entity to be ignored or overlooked. For example, entities that are collaborating together on a project or on an advertising campaign may find it convenient to share ideas by initiating messages to each other in an online system, but such messages may be mistaken for spam and therefore ignored.

### SUMMARY

An online system assigns a level of trust between a “requesting entity” and a “target entity” that is used to determine whether to permit or deny a request to perform an action initiated by the requesting entity that is directed towards the target entity (e.g., communicating a message from the requesting entity to the target entity). The requesting entity and the target entity each are associated with a set of users (e.g., employees of the entities) that may be connected to each other in the online system. For example, a user associated with the requesting entity may be connected to one or more users associated with the target entity. When the online system receives a request from the requesting entity to perform an action directed towards the target entity, the online system identifies connections maintained by the online system between the users associated with the requesting entity and the users associated with the target entity and assigns a level of trust based at least in part on these connections. Once the level of trust between the requesting entity and the target entity has been assigned, the level of trust may be stored by the online system. For example, the level of trust may be stored in association with a connection between the requesting entity and the target entity (e.g., in an edge between nodes representing the requesting entity and the target entity in a social graph maintained by the online system).

The online system then determines whether the assigned level of trust between the requesting entity and the target entity exceeds a threshold level of trust. If the assigned level of trust exceeds the threshold level of trust, the online system permits the requesting entity to perform the action directed towards the target entity; otherwise, the online system denies the request. For example, if the requesting entity requests to initiate a message that comprises an advertisement or other types of spam to the target entity via the online system and the assigned level of trust between the entities does not exceed a threshold level of trust, the online system may determine that the requesting entity is not permitted to initiate the message. However, if the assigned level of trust between the entities in the previous example exceeds the threshold level of trust, the online system may determine that the requesting entity is permitted to initiate the message to the target entity.

The online system may determine whether the requesting entity is permitted to perform an action directed towards the target entity by determining a set of actions permitted between the requesting entity and the target entity corresponding to the level of trust assigned between the entities and by comparing the action requested by the requesting entity to the permitted set of actions. For example, the online system may determine that a certain level of trust between the requesting entity and the target entity corresponds to permitting the requesting entity to indicate a preference for content posted by the target entity and to share content with the target entity that does not include advertisements or other types of spam. In this example, the online system may determine that an even higher level of trust between the requesting entity and the target entity corresponds to permitting the requesting entity to indicate a preference for content posted by the target entity and to share any type of content with the target entity. In the above examples, by comparing the action requested by the requesting entity to the permitted set of actions, the online system may determine that the requesting entity is permitted to share an advertisement with the target entity if the level of trust between the entities is at least the higher level of trust.

In some embodiments, the set of actions permitted between the requesting entity and the target entity corresponding to the level of trust assigned between the entities may be reciprocal, such that the set of actions the requesting entity is permitted to perform that are directed towards the target entity are the same set of actions the target entity is permitted to perform that are directed towards the requesting entity. Additionally, rather than determining a set of actions permitted between the entities corresponding to the level of trust assigned between the entities, in some embodiments, the online system may determine a set of actions restricted between the entities corresponding to the level of trust assigned between the entities. Information describing the permitted or restricted actions corresponding to a level of trust assigned between two entities may be stored in association with one or more connections between the entities.

The online system may assign the level of trust between the requesting entity and the target entity based on the number of connections between the users associated with the requesting entity and the users associated with the target entity. For example, the online system may assign the level of trust between the requesting entity and the target entity based on an assumption that the greater the number of connections between the users associated with the requesting entity and the users associated with the target entity, the greater the level of trust between the requesting entity and the target entity. In this example, the level of trust assigned by the online system between the requesting entity and the target entity is proportional to the number of connections between the users associated with the requesting entity and the users associated with the target entity.

The online system also may assign the level of trust between the requesting entity and the target entity based on the degrees of separation between the users associated with the requesting entity and the users associated with the target entity to which the users associated with the requesting entity are connected. A connection between a user associated with the requesting entity and a user associated with the target entity may be a direct connection, in which one degree of separation separates the users, or an indirect connection, in which more than one degree of separation separates the users. For example, in a social graph maintained by the online system in which each user of the online system is represented by a node and a connection between two users is represented by an edge between nodes representing the users, the number of edges required to connect the two users indicates the number of degrees of separation between the users. The online system may assign the level of trust between the requesting entity and the target entity based on an assumption that the degrees of separation between the users associated with the requesting entity and the users associated with the target entity are indicative of the level of trust between the entities. For example, the degrees of separation between the users associated with the requesting entity and the users associated with the target entity may be inversely proportional to the level of trust assigned between the two entities.

In various embodiments, the level of trust between the requesting entity and the target entity may be assigned based on information stored in association with connections between the users associated with the requesting entity and the users associated with the target entity. The information stored in association with a connection between a user associated with the requesting entity and a user associated with the target entity may indicate different types of relationships between the users (e.g., business relationships, friendships, familial relationships, etc.), such that the connection may be weighted based on a type of relationship between the users. For example, business relationships between the users may be weighted more heavily than friendships between the users when assigning the level of trust between the requesting entity and the target entity. The level of trust between the requesting entity and the target entity also may be assigned based on a duration of a connection between a user associated with the requesting entity and a user associated with the target entity, where older connections are weighted more heavily than newer connections. Furthermore, the online system may assign the level of trust between the requesting entity and the target entity based on information describing interactions between users associated with the requesting entity and users associated with the target entity that is stored in association with connections between the users. For example, the connections may be weighted in proportion to the frequency with which messages are sent between the users, the number of times the users shared content with each other, etc. As an additional example, a connection between users that has been established for 20 years may be weighted less heavily than an additional connection between users that has been established for two years if the users in the former connection have not interacted in the online system 140 within the previous two years, but the users in the latter connection have frequently interacted in the online system 140 within the previous two years.

Multiple connections may exist between a user associated with the requesting entity and a user associated with the target entity. For example, the users may be connected via a direct connection and multiple indirect connections, such that in a social graph, multiple paths exist that connect the nodes representing the users. If multiple connections exist between the same users associated with the requesting entity and the target entity, different subsets of the connections may be used to assign the level of trust between the entities. In some embodiments, each connection between the same users associated with the requesting entity and the target entity is used to assign the level of trust between the entities. For example, if a direct connection and three indirect connections exist between an employee of the requesting entity and an employee of the target entity, each connection is used to assign the level of trust between the requesting entity and the target entity. In other embodiments, only a subset of connections between the same users associated with the requesting entity and the target entity may be used to assign the level of trust between the entities. For example, only the connection with the fewest degrees of separation between the same employees of the requesting entity and the target entity (e.g., the direct connection in the previous example) may be used to assign the level of trust between the requesting entity and the target entity.

In some embodiments, the online system may assign the level of trust between the requesting entity and the target entity absent receiving a request from the requesting entity to perform an action directed towards the target entity. For example, the online system may periodically update the level of trust assigned between the requesting entity and the target entity, as well as information describing a set of actions permitted or restricted between the entities corresponding to the level of trust. In this example, the updated level of trust and information describing permitted or restricted actions may be stored in association with the connection between the entities for subsequent retrieval. For example, upon receiving a request from the requesting entity to perform an action directed towards the target entity, or vice versa, the online system may retrieve information stored in association with a connection between the entities describing the actions permitted or restricted between the entities and determine whether to permit the action by comparing the requested action to the information.

In various embodiments, the level of trust between the requesting entity and the target entity may be used to determine whether to permit or deny a request received from the requesting entity that is not directed towards the target entity. For example, the online system may use the level of trust between the requesting entity and the target entity and a level of trustworthiness associated with the target entity to determine whether to permit the requesting entity to create an advertising account that is associated with an amount of credit that may be spent on advertising services provided by the online system. Doing so would enable the online system to allow some entities that will end up being good customers (i.e., entities that do not default on their payments) to create more advertising accounts and/or to extend more credit to such entities. Similarly, the online system also may use this approach to limit the number of accounts that may be created by some entities that will end up being bad customers (i.e., entities that default on their payments) and/or to limit the amount of credit extended to such entities.

In some embodiments, the online system may use the level of trust between the requesting entity and the target entity and information indicating a level of trustworthiness associated with the target entity to determine whether to extend an amount of credit to the requesting entity. For example, suppose that the online system receives a request from the requesting entity to create an advertising account. If the target entity is included in a network of trusted entities (i.e., a “trusted network”), and the level of trust between the requesting entity and the target entity is at least a threshold level, the online system may permit the requesting entity to create the advertising account. Similarly, if the target entity is included in a network of untrusted entities (i.e., an “untrusted network”), and the level of trust between the requesting entity and the target entity is at least the threshold level, the online system may deny the requesting entity's request to create the advertising account. In some embodiments, if the target entity is included in the trusted network, and the level of trust between the requesting entity and the target entity is at least a threshold level, the online system may update the trusted network to include the requesting entity. Similar updates may be made to the untrusted network as well if the target entity is included in the untrusted network and the level of trust between the requesting entity and the target entity is at least the threshold level.

The target entity may be identified as an entity of the trusted network based on information indicating whether the entity is associated with at least a threshold level of trustworthiness, such as historical information associated with the target entity indicating credit-worthiness. For example, the target entity is considered a trusted entity if it has at least three advertising accounts with the online system that each are associated with at least a threshold amount of credit, and the target entity has never defaulted on a payment to the online system for advertising services for at least the previous eight years. In this example, the online system also may determine whether the target entity should be included in the trusted network based on the frequency and amounts of the target entity's previous purchases of advertising services provided by the online system and any other suitable indicators of credit-worthiness.

The target entity also may be identified as an entity of the trusted network based on historical spending information associated with the target entity that is discounted by an amount that the online system has not yet collected and/or by an amount charged by the online system that may be subject to reversal (e.g., chargeback of a disputed amount). For example, the target entity is included in the trusted network if the total amount the target entity spent on advertising in the previous year, when adjusted by any pending payments towards the total amount, is at least a threshold amount. The online system may identify amounts not yet collected by the online system and/or amounts that may be subject to reversal based on geographic information associated with the trusted entity, payment information provided by the trusted entity, and/or an amount of time elapsed since a payment was made. For example, different policies may apply to entities located in different geographic locations, such that the timeframe within which a charge may be disputed may vary for different entities based on their geographic location. As an additional example, recent payments made by credit cards may be subject to reversal while older payments made by credit cards and by withdrawals from a bank account are less likely to be subject to reversal.

Based on the level of trust between the requesting entity and the target entity and the level of trustworthiness associated with the target entity, the online system may determine a number of advertising accounts and/or an amount of credit to allocate to the requesting entity. For example, if the level of trust between the requesting entity and the target entity is at least a threshold level of trust and the level of trustworthiness associated with the target entity is at least a threshold level of trustworthiness, the online system may permit the new entity to create a specified number of advertising accounts and/or allocate a specific amount of credit to the new entity. As an additional example, the online system may determine whether to allocate an additional advertising account to the requesting entity and/or whether to increase the amount of credit to extend to the requesting entity in its existing advertising account(s) based on the level of trust between the requesting entity and the target entity and the level of trustworthiness associated with the target entity.

In one embodiment, the online system uses the level of trust between the requesting entity and the target entity as well as the level of trustworthiness associated with the target entity to determine whether advertisement requests received from the requesting entity should be manually reviewed. For example, if the level of trust assigned between the requesting entity and the target entity for the requesting entity is moderate and the target entity is associated with at least a threshold level of trustworthiness, the online system may permit the requesting entity to create a new advertising account and allocate a specified amount of credit to the account, but may require advertisement requests received from the requesting entity to be manually reviewed for compliance with advertising policies before presenting them to users of the online system.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for determining whether to permit a requesting entity to perform an action directed towards a target entity via an online system, in accordance with an embodiment.

FIG. 4 is an example social graph used to identify connections between users associated with a requesting entity and users associated with a target entity, in accordance with an embodiment.

FIG. 5 is a flow chart of a method for determining whether to permit a requesting entity of an online system to create an advertising account associated with a user profile associated with the requesting entity, in accordance with an embodiment.

FIG. 6 is an example social graph used to identify entities of a network of trusted entities of the online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

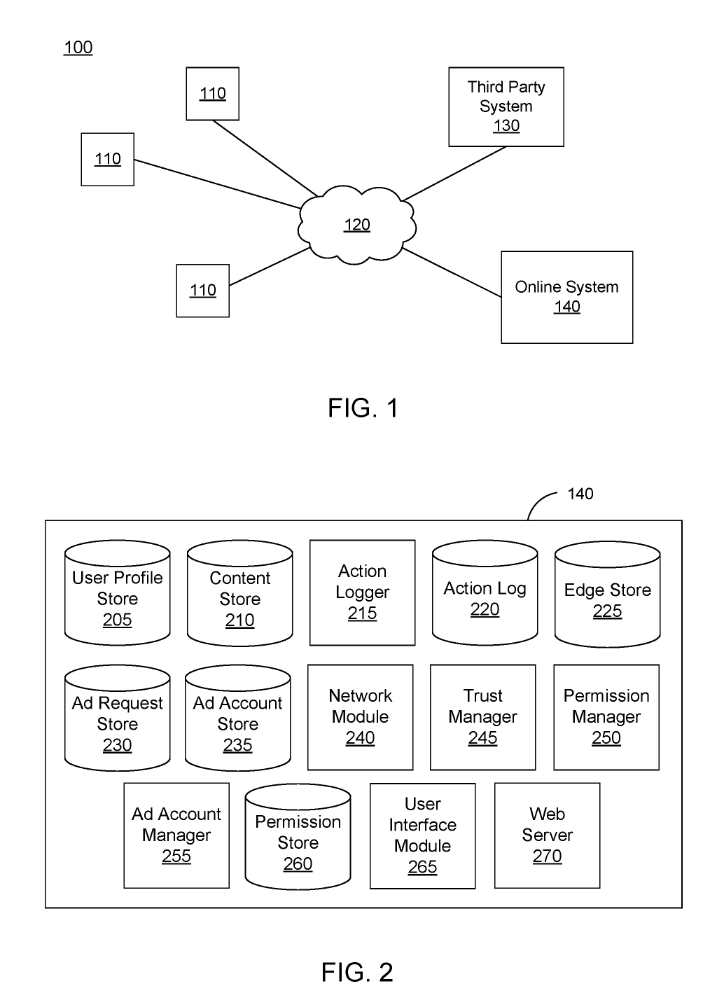

FIG. 1 is a block diagram of a system environment 100 for an online system 140. The system environment 100 shown by FIG. 1 comprises one or more client devices 110, a network 120, one or more third party systems 130, and the online system 140. In alternative configurations, different and/or additional components may be included in the system environment 100. The embodiments described herein may be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 also may communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an ad request store 230, an ad account store 235, a network module 240, a trust manager 245, a permission manager 250, an ad account manager 255, a permission store 260, a user interface module 265, and a web server 270. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

While user profiles in the user profile store 205 are frequently associated with individuals, allowing individuals to interact with each other via the online system 140, user profiles also may be stored for entities such as businesses or organizations. This allows an entity to establish a presence in the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions in the online system 140, as well as actions in the third party system 130 that communicate information to the online system 140. Users may interact with various objects in the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the online system 140 as well as with other applications operating in the online system 140. In some embodiments, data from the action log 220 is used to infer interests or preferences of a user, augmenting the interests included in the user's user profile and allowing a more complete understanding of user preferences.

The action log 220 also may store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the online system 140.

In one embodiment, the edge store 225 stores information describing connections between users and other objects in the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page in the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

In some embodiments, the edge store 225 stores information describing one or more connections between users associated with a requesting entity and users associated with a target entity. Connections between users of the online system 140 may be stored in a graph (e.g., a social graph) maintained by the online system 140 and stored in the edge store 225. The social graph may include several nodes, in which each node corresponds to an object maintained by the online system 140, (e.g., an entity or a user of the online system 140). The social graph also may include edges that connect the nodes, in which each edge corresponds to a connection between two or more objects.

A connection between two objects maintained by the online system 140 may be characterized based on the degrees of separation between them. The number of degrees separating two objects is equal to the number of edges required to connect the objects in the social graph. For example, one degree of separation separates users with a direct connection to each other. As an additional example, more than one degree of separation exists between users with an indirect connection (e.g., two degrees separate users who are both connected to a mutual friend). Multiple connections may exist between two objects maintained by the online system 140. For example, two users may be connected via a direct connection and multiple indirect connections, such that in a social graph, multiple paths exist that connect the nodes representing the users. In this example, the degrees of separation between the users may be equal to the degrees of separation corresponding to the shortest path connecting the nodes representing the users.

The edge store 225 may store information describing connections between entities (e.g., a requesting entity and a target entity). In embodiments in which the online system 140 assigns a value indicating a level of trust between two entities, the value may be stored in association with a connection between the entities (e.g., in an edge between nodes representing a requesting entity and a target entity in a social graph maintained by the online system 140). Furthermore, in such embodiments, information describing a set of actions permitted or restricted between the entities corresponding to the level of trust also may be stored in association with the connection. For example, on a scale of one to 10, with 10 indicating the highest level of trust, if the level of trust between two entities has a value of one, information stored in association with a connection between the entities may indicate that no messages are permitted to be exchanged between the entities. In contrast, if the level of trust between the two entities in the above example has a value of 10, information stored in association with a connection between the entities may indicate that the exchange of messages containing any type of content that does not violate the policies of the online system 140 is permitted between the entities.

The edge store 225 may store information describing a network of users of the online system 140. In some embodiments, the network may include individual users as well as entities (e.g., advertisers and advertising agencies). The network may be defined based on a level of trustworthiness associated with entities included in the network. For example, entities of a trusted network are associated with at least a threshold level of trustworthiness. As an additional example, entities of an untrusted network are associated with less than a threshold level of trustworthiness. The level of trustworthiness associated with an entity may be determined by the trust manager 245, which is further described below.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if a user interacts with the advertisement in the ad request when presented to the user, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 for presenting the advertisement may be determined by multiplying the bid amount by a probability of the advertisement being accessed by a user.

Additionally, an ad request may include one or more targeting criteria specified by the advertiser. Targeting criteria included in an ad request specify one or more characteristics of users eligible to be presented with advertisement content in the ad request. For example, targeting criteria are used to identify users associated with user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria also may specify interactions between a user and objects performed external to the online system 140, such as on a third party system 130. For example, targeting criteria identifies users who have performed a particular action, such as having sent a message to another user, having used an application, having joined or left a group, having joined an event, having generated an event description, having purchased or reviewed a product or service using an online marketplace, having requested information from a third party system 130, having installed an application, or having performed any other suitable action. Including actions in targeting criteria allows advertisers to further refine users eligible to be presented with advertisement content from an ad request. As another example, targeting criteria identifies users having a connection to another user or object or having a particular type of connection to another user or object.

The advertisement account store (“ad account store”) 235 stores historical information describing advertising accounts and/or amounts of credit associated with user profiles maintained by the online system 140. An advertising account is associated with an amount of credit that may be spent by an entity or other user associated with the account on advertising services provided by the online system 140. Multiple advertising accounts with different amounts of credit may be associated with a particular user profile. Information describing an advertising account associated with a user profile may include general information (e.g., the date the account was created, the amount of credit initially allocated to the account, dates and amounts of increases in credit allocated to the account, etc.), account activity (e.g., frequency and amounts of charges), information describing invoices for ad charges (e.g., balances owed on the account, descriptions of advertising services rendered, etc.), payment history (e.g., dates and amounts of payments made on the account, form of payment, whether payments were late or made in full, etc.), and any other suitable information associated with the advertising account.

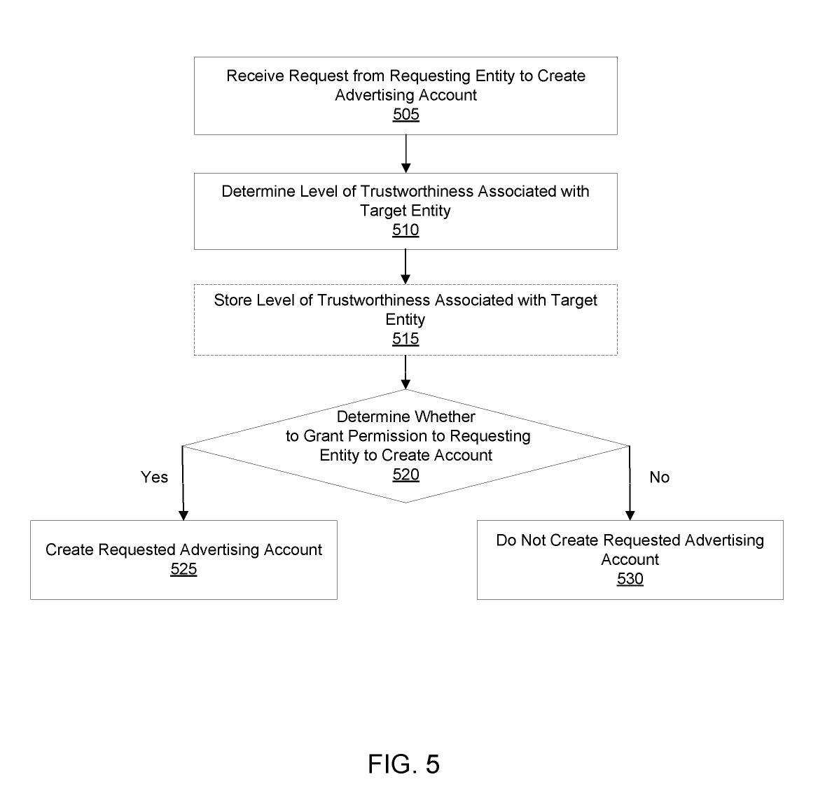

The ad account store 235 also may store information describing requests submitted by entities and other online system users to create advertising accounts and/or to allocate an amount of credit to an advertising account. For example, the ad account store 235 may store dates that an entity requested to create an advertising account, dates that the entity requested that the online system 140 allocate more credit to an existing advertising account, and the outcomes of the requests. In embodiments in which the online system 140 determines a score or other value that indicates a measure of trustworthiness associated with an entity or other user, the score or value may be stored in the ad account store 235 in association with information identifying the entity or user. The ad account store 235 is further described below in conjunction with FIG. 5.

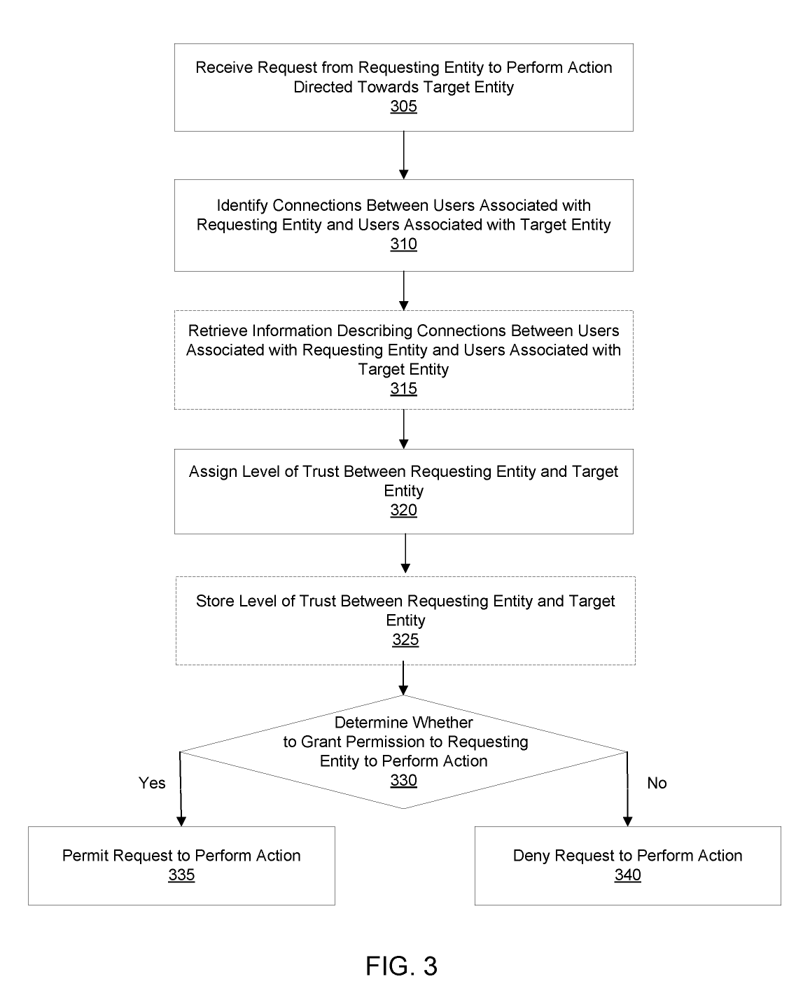

The network module 240 identifies connections between online system users associated with a requesting entity and online system users associated with a target entity. For example, the network module 240 identifies connections between a user associated with the requesting entity and a user associated with the target entity by accessing information stored in the edge store 225 (e.g., a social graph maintained by the online system 140) to determine whether a connection exists between the users. Once the network module 240 has identified connections between users associated with the requesting entity and users associated with the target entity, the network module 240 may retrieve information describing the connections (e.g., the number of connections between a user associated with the requesting entity and a user associated with the target entity and the degrees of separation between the users). The network module 240 also may retrieve information stored in association with the connections. Examples of types of information stored in association with a connection between users include a duration of the connection, information describing a type of connection between the users, such as business relationships (e.g., co-workers, client-agency relationships) and personal relationships (e.g., friendships and familial relationships), information describing transactions between the users (e.g., content shared by the users, messages exchanged between the users, a number/dollar amount of business transactions between the users, etc.), and any other suitable types of information describing the connection between the users. The functionality of the network module 240 is further described below in conjunction with FIGS. 3, 4, and 6.

The trust manager 245 may assign a level of trust between a requesting entity and a target entity based at least in part on the connections between users associated with the requesting entity and users associated with the target entity. In some embodiments, the trust manager 245 assigns the level of trust based at least in part on the number of connections between the users associated with the requesting entity and the users associated with the target entity. For example, the trust manager 245 may assign the level of trust between the requesting entity and the target entity based on an assumption that the greater the number of connections between the users associated with the requesting entity and the users associated with the target entity, the greater the level of trust between the requesting entity and the target entity. In this example, the level of trust assigned by the trust manager 245 between the requesting entity and the target entity is proportional to the number of connections between the users associated with the requesting entity and the users associated with the target entity.

The trust manager 245 also may assign a level of trust between a requesting entity and a target entity based on the degrees of separation between users associated with the requesting entity and users associated with the target entity to which the users associated with the requesting entity are connected. The trust manager 245 may assign the level of trust between the requesting entity and the target entity based on an assumption that the degrees of separation between the users associated with the requesting entity and the users associated with the target entity are indicative of the level of trust between the entities. For example, the trust manager 245 may assign the level of trust between the requesting entity and the target entity based on the degrees of separation between the users associated with the requesting entity and the users associated with the target entity, such that the level of trust is inversely proportional to the degrees of separation.

Multiple connections may exist between a user associated with a requesting entity and a user associated with a target entity. For example, the users may be connected via a direct connection and multiple indirect connections, such that in a social graph, multiple paths exist that connect the nodes representing the users. In this example, the degrees of separation between the users may be equal to the degrees of separation corresponding to the shortest path connecting the nodes representing the users. In some embodiments, each of multiple connections between the same users associated with the requesting entity and the target entity is used to assign the level of trust between the entities. For example, if a direct connection and three indirect connections exist between an employee of the requesting entity and an employee of the target entity, each connection is used to assign the level of trust between the requesting entity and the target entity. In other embodiments, if multiple connections exist between the same users associated with the requesting entity and the target entity, only a subset of the connections may be used to assign the level of trust between the entities. For example, only the connection with the fewest degrees of separation between the same employees of the requesting entity and the target entity (e.g., the direct connection in the previous example) may be used to assign the level of trust between the requesting entity and the target entity.

In various embodiments, the level of trust between the requesting entity and the target entity may be assigned based on information stored in association with the connections. The information stored in association with a connection between a user associated with the requesting entity and a user associated with the target entity may indicate different types of relationships between the users who are connected (e.g., business relationships, friendships, familial relationships, etc.), such that the connection may be weighted based on a type of relationship between the users. For example, the trust manager 245 may weight a connection between two users more heavily if a business relationship exists between the users than if a friendship exists between the users when assigning the level of trust between entities with which the users are associated. The level of trust between the requesting entity and the target entity also may be assigned based on a duration of a connection between a user associated with the requesting entity and a user associated with the target entity, where older connections are weighted more heavily than newer connections. Furthermore, the trust manager 245 may assign the level of trust between the requesting entity and the target entity based on information describing interactions between users associated with the requesting entity and users associated with the target entity that is stored in association with connections between the users. For example, the connections may be weighted in proportion to the frequency with which messages are sent between the users, the number of times the users share content with each other, etc. As an additional example, a connection between users that has been established for 20 years may be weighted less heavily than an additional connection between users that has been established for two years if the users in the former connection have not interacted in the online system 140 within the previous two years, but the users in the latter connection have frequently interacted in the online system 140 within the previous two years.

In some embodiments, the trust manager 245 may assign a level of trust between a requesting entity and a target entity absent receiving a request from the requesting entity to perform an action directed towards the target entity. For example, the trust manager 245 may update the level of trust assigned between the requesting entity and the target entity, as well as information describing a set of actions permitted or restricted between the entities corresponding to the level of trust. The trust manager 245 may update this information periodically or in response to receiving a request to establish, delete, or modify a connection between a user associated with the requesting entity and a user associated with the target entity. The updated level of trust and information describing permitted or restricted actions may be stored in association with the connection between the entities for subsequent retrieval. For example, upon receiving a request from the requesting entity to perform an action directed towards the target entity, or vice versa, the permission manager 250 (described below) may retrieve information describing the set of actions permitted or restricted between the entities and determine whether to permit the action by comparing the requested action to the information.

In some embodiments, the trust manager 245 determines a level of trustworthiness associated with a target entity. The level of trustworthiness may be determined based on historical information associated with the target entity indicating a level of credit-worthiness. For example, the trust manager 245 determines a level of trustworthiness associated with the target entity based on the number of advertising accounts the target entity has with the online system 140, whether the target entity actively uses the accounts, an average amount the target entity spends each year on advertising services provided by the online system 140, and whether the target entity has ever defaulted on a payment to the online system 140 in exchange for advertising services.

In some embodiments, the target entity is included in a trusted network if the target entity is associated with at least a threshold level of trustworthiness. The trust manager 245 may identify entities and other users of a trusted network based on historical information associated with each of the trusted entities/users indicating at least a threshold measure of credit-worthiness (e.g., information stored in the ad account store 235 and/or user profile store 205). For example, an advertiser or advertising agency is considered a trusted entity if it has at least three advertising accounts with the online system 140, actively uses the accounts every month, has spent at least $10,000 on advertising each year for at least the previous eight years, and the advertiser or advertising agency has never defaulted on a payment to the online system 140 in exchange for advertising services during those eight years. In some embodiments, the historical information used to identify entities of the trusted network may correspond to a frequency or seasonality of advertisement purchases made by the entities. For example, if an entity primarily purchases advertisements for snow tires, rather than using a total amount spent by the entity to determine the credit-worthiness of the user, the trust manager 245 determines the credit-worthiness of the entity based on the entity's average monthly advertisement purchases during months in the winter and late fall.

In some embodiments, when identifying entities of the trusted network, the trust manager 245 discounts historical spending information associated with the entities by an amount that the online system 140 has not yet collected or by an amount charged by the online system 140 that may be subject to reversal (e.g., chargeback of a disputed amount). For example, an entity is included in the trusted network if the total amount the entity spent on advertising in the previous year, when adjusted by any pending payments towards the total amount, is at least a threshold amount. The trust manager 245 may identify amounts not yet collected by the online system 140 and/or amounts that may be subject to reversal based on geographic information associated with entities and/or payment information provided by the entities. For example, different policies may apply to entities located in different geographic locations, such that the timeframe within which a charge may be disputed may vary for different entities based on their geographic location. As an additional example, recent payments made by credit cards may be subject to reversal while older payments made by credit cards and by withdrawals from a bank account are less likely to be subject to reversal.

The trust manager 245 also may identify entities of the trusted network based on information stored in the edge store 225 indicating connections between the entities. For example, once the trust manager 245 has identified a trusted entity of the online system 140, the network module 240 may retrieve information from the edge store 225 describing connections between the trusted entity and additional entities/users of the online system 140. In this example, the trust manager 245 may then determine whether each additional entity/user to which the trusted entity is connected is also a trusted entity/user. Additional entities/users connected to the trusted entity who are determined to be trusted entities/users are also identified as part of the trusted network while additional entities/users connected to the trusted entity who are not determined to be trusted entities/users are not identified as part of the trusted network.

Alternatively, the target entity may be included in an untrusted network if the target entity is associated with less than a threshold level of trustworthiness. The trust manager 245 may identify entities and other users of the untrusted network based on similar types of information used to identify entities and other users of the trusted network. In one embodiment, the trust manager 245 may identify entities/users of the untrusted network based on information indicating that the entities/users are associated with less than a threshold measure of credit-worthiness. For example, an advertiser or advertising agency is considered an untrusted entity if it has fewer than two advertising accounts with the online system 140 and does not actively use the accounts every month, or has defaulted on a payment to the online system 140 for at least 10% of their spending on advertising services during any of the previous eight years.

In some embodiments, the trust manager 245 also may use the level of trust assigned between the requesting entity and the target entity and the level of trustworthiness associated with the target entity to determine whether to add the requesting entity to the trusted network. The requesting entity may be added to the trusted network based on the level of trust assigned between the requesting entity and the target entity and the level of trustworthiness associated with the target entity, based on an effect of the level of trust assigned between the requesting entity and the target entity and the level of trustworthiness associated with the target entity, or based on some combination of attributes associated with the requesting entity. For example, the requesting entity may be added to the trusted network if the amount of credit allocated to the requesting entity is at least a threshold amount or the number of advertising accounts allocated to the requesting entity reaches a maximum number permitted by the online system 140. As an additional example, the requesting entity may be added to the trusted network if the level of trust assigned between the requesting entity and the target entity is at least a threshold level of trust, the level of trustworthiness associated with the target entity is at least a threshold level of trustworthiness, and the online system 140 has maintained an advertising account for the requesting entity for at least 10 years.

The trust manager 245 also may use the level of trust assigned between the requesting entity and the target entity and the level of trustworthiness associated with the target entity to determine whether to add the requesting entity to the untrusted network. For example, the requesting entity may be added to the untrusted network if the amount of credit allocated to the requesting entity is at least a threshold amount and the requesting entity has defaulted on a payment for advertising services provided by the online system 140 within the last three years. As an additional example, the requesting entity may be added to the untrusted network if the level of trust assigned between the requesting entity and the target entity is at least a threshold level of trust, the level of trustworthiness associated with the target entity is less than a threshold level of trustworthiness, and the online system 140 has not maintained an advertising account for the requesting entity for at least 10 years. The functionality of the trust manager 245 is further described below in conjunction with FIGS. 3, 5, and 6.

The permission manager 250 may determine whether to grant or deny permission to a requesting entity to perform an action directed towards a target entity based at least in part on the level of trust between the requesting entity and the target entity assigned by the trust manager 245. In some embodiments, the permission manager 250 makes this determination based on whether the assigned level of trust between the requesting entity and the target entity exceeds a threshold level of trust associated with the requested action (e.g., retrieved from the permission store 260, described below). If the assigned level of trust exceeds the threshold level of trust associated with the requested action, the permission manager 250 may determine that the requesting entity should be permitted to perform the action directed towards the target entity; otherwise, the permission manager 250 may determine that the request should be denied. For example, if the requesting entity is requesting to initiate a message that comprises an advertisement or other types of spam to the target entity via the online system 140, the permission manager 250 may deny the request if the assigned level of trust between the entities does not exceed a threshold level of trust associated with sending spam.

The permission manager 250 may determine whether to grant or deny permission to the requesting entity to perform an action directed towards the target entity by first determining a set of actions permitted between the requesting entity and the target entity corresponding to the level of trust assigned between the entities and by comparing the action requested by the requesting entity to the permitted set of actions. For example, the permission manager 250 may determine that a certain level of trust between the requesting entity and the target entity corresponds to permitting the requesting entity to indicate a preference for content posted by the target entity and to share content with the target entity that does not include advertisements or other types of spam. In this example, the permission manager 250 may determine that an even higher level of trust between the requesting entity and the target entity corresponds to permitting the requesting entity to indicate a preference for content posted by the target entity and to share any type of content with the target entity. In the above examples, by comparing the action requested by the requesting entity to the permitted set of actions, the permission manager 250 may determine that the requesting entity is permitted to share an advertisement with the target entity if the level of trust between the entities is at least the higher level of trust. The set of actions permitted between the requesting entity and the target entity corresponding to the level of trust assigned between the entities may be reciprocal, such that the set of actions the requesting entity is permitted to perform that are directed towards the target entity are the same set of actions the target entity is permitted to perform that are directed towards the requesting entity.

Additionally, rather than determining a set of actions permitted between the entities corresponding to the level of trust assigned between the entities, in some embodiments, the permission manager 250 may determine a set of actions restricted between the entities corresponding to the level of trust assigned between the entities. Information describing the permitted or restricted actions corresponding to a level of trust assigned between two entities may be stored (e.g., in the permission store 260 and/or in association with one or more connections between the entities in the edge store 225).

Once the permission manager 250 has determined whether to grant or deny permission to the requesting entity to perform an action directed towards the target entity based on the level of trust between the requesting entity and the target entity, the permission manager 250 may permit or deny the request accordingly. For example, if the requesting entity has requested to send a message to the target entity, the permission manager 250 may communicate the message to the target entity upon determining that the request should be granted. Alternatively, in the previous example, the permission manager 250 may block the message upon determining that the request should not be granted. The functionality of the permission manager 250 is further described below in conjunction with FIG. 3.

The ad account manager 255 may determine whether to grant or deny permission to a requesting entity to create an advertising account. The ad account manager 255 determines whether to grant or deny permission to the requesting entity to create the advertising account based on a level of trust between the requesting entity and the target entity assigned by the trust manager 245 and a level of trustworthiness associated with the target entity. For example, if the requesting entity has requested to create an advertising account associated with its user profile maintained by the online system 140, the level of trust between the entities is at least a threshold level of trust, and the level of trustworthiness associated with the target entity is at least a threshold level of trustworthiness, the ad account manager 255 may grant the requesting entity's request to create an advertising account. However, if the level of trust between the entities in this example is less than the threshold level of trust and/or the level of trustworthiness associated with the target entity is less than the threshold level of trustworthiness, the ad account manager 255 may not permit the requesting entity to create the advertising account.

In some embodiments, the ad account manager 255 may determine whether to grant or deny permission to the requesting entity to create multiple advertising accounts. For example, the online system 140 may allow the requesting entity to specify a number of advertising accounts in their request to create the advertising accounts. In such embodiments, the ad account manager 255 may determine whether to allocate the requested number of advertising accounts to the requesting entity based on the level of trust between the requesting entity and the target entity and the level of trustworthiness associated with the target entity, such that the number of advertising accounts that may be allocated is proportional to level of trust and/or the level of trustworthiness.

If the ad account manager 255 determines that a request from the requesting entity to create a specified number of advertising accounts should not be granted, the ad account manager 255 may deny the request, but offer to allow the requesting entity to create fewer advertising accounts. For example, different ranges of levels of trust between the requesting entity and the target entity and/or different levels of trustworthiness associated with the target entity may be associated with different numbers of advertising accounts such that the number of advertising accounts is proportional to the different ranges of levels of trust and/or different levels of trustworthiness. In this example, if the level of trust between the requesting entity and the target entity is less than a threshold level of trust and/or the level of trustworthiness associated with the target entity is less than a threshold level of trustworthiness, the ad account manager 255 may deny the requesting entity's request to create the number of advertising accounts requested, but offer to allow the requesting entity to create a smaller number of advertising accounts for which the level of trust and/or level of trustworthiness qualify.

The number of advertising accounts allocated to the requesting entity may be inversely proportional to the amount of credit allocated to each advertising account. In one embodiment, the ad account manager 255 may allocate various numbers of advertising accounts to the requesting entity as long as the total amount of credit allocated to the requesting entity is equal to or less than a maximum amount. For example, the ad account manager 255 may allocate one advertising account to the requesting entity that is allocated $2,000 in credit, two advertising accounts that each are allocated $1,000 in credit, three advertising accounts that each are allocated $666 in credit, etc.

The ad account manager 255 may determine whether to grant or deny a requesting entity's request to allocate an amount of credit to the requesting entity. The ad account manager 255 may determine whether to allocate an amount of credit to an account associated with the requesting entity (e.g., a newly-created advertising account or an existing advertising account) based on the level of trust between the requesting entity and the target entity and/or the level of trustworthiness associated with the target entity. For example, different amounts of credit may be associated with different ranges of levels of trust between the entities and/or different levels of trustworthiness associated with the target entity, such that the greater the amount of credit being requested by the requesting entity, the higher the level of trust and/or level of trustworthiness required in order for the ad account manager 255 to grant the request.

If the ad account manager 255 determines that the requesting entity's request for an amount of credit should not be granted, the ad account manager 255 may deny the request, but offer a lesser amount of credit to allocate to the requesting entity. In the previous example, if the level of trust between the requesting entity and the target entity is less than a threshold level of trust and/or the level of trustworthiness associated with the target entity is less than a threshold level of trustworthiness required for the ad account manager 255 to allocate the amount of credit being requested, the ad account manager 255 may deny the request. However, the ad account manager 255 may offer the requesting entity a lesser amount of credit for which the level of trust between the entities and/or the level of trustworthiness associated with the target entity qualify.

If the ad account manager 255 grants the requesting entity's request to create a new advertising account, the ad account manager 255 allocates the new advertising account to the requesting entity. The ad account manager 255 also may allocate an amount of credit to a new or existing advertising account associated with the requesting entity. If the ad account manager 255 allocates an amount of credit to a new advertising account, the amount of credit allocated may be a default amount. For example, every new advertising account may be associated with a default of $5,000 in credit. Alternatively, the amount of credit allocated to a new or existing advertising account may be specified by the requesting entity (e.g., in the request received from the requesting entity). As another alternative, the amount of credit allocated to a new or existing advertising account may be determined by the ad account manager 255 (e.g., based on the level of trust assigned between the requesting entity and the target entity and/or the level of trustworthiness associated with the target entity).

In one embodiment, the ad account manager 255 uses the level of trust assigned between the requesting entity and the target entity and/or the level of trustworthiness associated with the target entity to determine whether advertisement requests received from the requesting entity should be manually reviewed. For example, if the level of trust assigned between the requesting entity and the target entity and/or the level of trustworthiness associated with the target entity are within a range of levels, the ad account manager 255 may permit the requesting entity to create a new advertising account and allocate a specified amount of credit to the account, but may require advertisement requests received from the requesting entity to be manually reviewed for compliance with advertising policies before presenting them to users of the online system 140. The functionality of the ad account manager 255 is further described below in conjunction with FIG. 5.

The permission store 260 stores information describing various levels of trust assigned between a requesting entity and a target entity that are associated with various actions that may be performed by the requesting entity that are directed towards the target entity. In one embodiment, a higher level may be required in order for the requesting entity to perform an action directed towards the target entity that is likely to be considered objectionable by the target entity than may be required in order for the requesting entity to perform an action directed towards the target entity that is not likely to be considered objectionable by the target entity. For example, a higher level of trust is required in order for the requesting entity to send a message including spam to the target entity than is required in order for the requesting entity to indicate a preference for content posted by the target entity.

In some embodiments, the permission store 260 includes different levels of trust between the requesting entity and the target entity that correspond to different sets of actions directed towards the target entity that the requesting entity is permitted to perform. For example, on a scale of one to 10, with 10 indicating the highest level of trust, a level of trust between two entities having a value of one may correspond to an empty set of actions that the requesting entity is permitted to perform (i.e., the requesting entity is not permitted to perform any actions directed towards a target entity). In the above example, a level of trust between two entities having a value of five may correspond to a set of actions that the requesting entity is permitted to perform (e.g., initiate a message to the target entity via the online system 140, as long as the content of the message does not include an advertisement or other types of spam). In some embodiments, the permission store 260 includes different levels of trust between the requesting entity and the target entity that correspond to different sets of actions directed towards the target entity that the requesting entity is prohibited from performing. For example, a level of trust between the two entities in the above examples having a value of 10 may correspond to an empty set of actions that the requesting entity is prohibited from performing (i.e., the requesting entity is not prohibited from performing any action directed towards the target entity via the online system 140 that is in compliance with the policies of the online system 140).

The permission store 260 also stores information describing various levels of trust required between a requesting entity and a target entity and/or levels of trustworthiness associated with the target entity associated with various numbers of advertising accounts and/or amounts of credit that may be allocated to the requesting entity. In one embodiment, the number of advertising accounts and/or amount of credit that may be allocated to the requesting entity is proportional to the level of trust required between the requesting entity and the target entity and/or the level of trustworthiness associated with the target entity.

The level of trustworthiness associated with the target entity corresponding to various numbers of advertising accounts and/or amounts of credit that may be allocated to the requesting entity may be expressed as an indication of whether the target entity exceeds a threshold level of trustworthiness (e.g., whether the target entity is included in the trusted network). For example, information stored in the permission store 260 may indicate that if a requesting entity is requesting to create at least 3 advertising accounts, the level of trust between the requesting entity and the target entity must exceed a threshold level of trust and the target entity must be included in the trusted network. The permission store 260 is further described below in conjunction with FIGS. 3 and 5.

The user interface module 265 generates a notification sent to the requesting entity notifying the requesting entity whether their request to perform an action in the online system 140 was granted or denied. In some embodiments, the notification is generated by the user interface module 265 in response to receiving a request from the requesting entity to perform an action directed towards the target entity. For example, if the permission manager 250 has determined that the requesting entity's request to perform an action directed towards the target entity should be granted, the user interface module 265 may generate a notification that is sent to the requesting entity that indicates that their request has been granted. In this example, the notification optionally may include elements facilitating the ability of the requesting entity to perform the action directed towards the target entity (e.g., an input field configured to receive text that may be included in a message the requesting entity is requesting to send to the target entity). As an additional example, if the permission manager 250 has determined that the requesting entity's request to perform an action directed towards the target entity should be granted, the user interface module 265 may generate a notification that is sent to the requesting entity that indicates that their request has been denied. In this example, the notification optionally may include an explanation as to why the request was denied (e.g., the requesting entity attempted to send spam to the target entity).

In other embodiments, a notification is generated by the user interface module 265 in response to receiving a request from the requesting entity to perform an action that is not directed towards the target entity. For example, if the online system 140 receives a request from the requesting entity to create one or more advertising accounts, the level of trust between the requesting entity and the target entity exceeds a threshold level of trust, and the level of trustworthiness associated with the target entity exceeds a threshold level of trustworthiness, the user interface module 265 may generate a notification that is sent to the requesting entity that indicates that their request has been granted. This notification may specify a number of advertising accounts allocated to the requesting entity, an amount of credit allocated to each of the accounts, etc. As an additional example, if the level of trust between the requesting entity and the target entity is less than the threshold level of trust and/or the level of trustworthiness associated with the target entity is less than the threshold level of trustworthiness, the user interface module 265 may generate a notification that is sent to the requesting entity that indicates that their request has been denied. A notification that is sent to the requesting entity indicating that their request has been denied may include details about why the request was denied (e.g., a maximum number of advertising accounts that may be associated with their user profile has been reached, a number of previous payments on which the requesting entity has defaulted, etc.).

In some embodiments, the notification may permit the requesting entity to provide one or more inputs related to the notification. For example, if the requesting entity has requested to create at least one advertising account, the notification may inform the requesting entity that they are permitted to create up to a maximum number of advertising accounts, in which the maximum number of advertising accounts is proportional to the level of trust between the requesting entity and the target entity and/or the level of trustworthiness associated with the target entity. In this example, the notification may include an input area that allows the requesting entity to specify a number of advertising accounts to create. As an additional example, the notification may include an input area that allows the requesting entity to create a name associated with a newly created advertising account or to associate one or more advertisements or advertising campaigns with the advertising account.

The notification also may include one or more interactive elements that allow the requesting entity to compare multiple advertising accounts and credit options that may be allocated to the requesting entity. For example, if the notification informs the requesting entity that their request to create three advertising accounts has been granted and that a maximum amount of $3,000 in credit may be allocated to the accounts, the notification may include radio buttons, drop-down menus, slider bars, etc. that allow the requesting entity to select an amount of credit to allocate to each account. In this example, if the requesting entity specifies amounts of credit to allocate to two accounts, the amount of credit allocated to the other account is automatically adjusted so that the total amount allocated to all three accounts does not exceed $3,000. The functionality of the user interface module 265 is further described below in conjunction with FIGS. 3 and 5.

The web server 270 links the online system 140 via the network 120 to the one or more client devices 110, as well as to the third party system 130 and/or one or more third party systems. The web server 270 serves web pages, as well as other content, such as JAVA®, FLASH®, XML and so forth. The web server 270 may receive and route messages between the online system 140 and the client device 110, for example, instant messages, queued messages (e.g., email), text messages, short message service (SMS) messages, or messages sent using any other suitable messaging technique. A user may send a request to the web server 270 to upload information (e.g., images or videos) that are stored in the content store 210 or to perform an action directed towards a target entity. Additionally, the web server 270 may provide application programming interface (API) functionality to send data directly to native client device operating systems, such as IOS®, ANDROID™, WEBOS® or BlackberryOS.

### Determining Whether to Permit an Action Directed Towards an Entity

FIG. 3 is a flow chart of a method for determining whether to permit a requesting entity to perform an action directed towards a target entity via an online system, according to one embodiment. In other embodiments, the method may include different and/or additional steps than those shown in FIG. 3. Additionally, steps of the method may be performed in a different order than the order described in conjunction with FIG. 3.

The online system 140 receives 305 a request from the requesting entity to perform an action directed towards the target entity. The requesting entity is associated with a first set of users of the online system 140 and the target entity is associated with a second set of users of the online system 140. For example, the requesting entity is associated with a set of employees of the requesting entity and the target entity is associated with a set of employees of the target entity.

The online system 140 identifies 310 (e.g., via the network module 240) connections maintained by the online system 140 between the first set of users and the second set of users. The network module 240 may access a social graph maintained by the online system 140 (e.g., stored the edge store 225) to identify connections between each user of the first set of users associated with the requesting entity and each user of the second set of users associated with the target entity. The social graph may include several nodes that each corresponds to an object (e.g., an entity) maintained by the online system 140. The social graph also may include edges connecting the nodes that each corresponds to a connection between two or more objects.

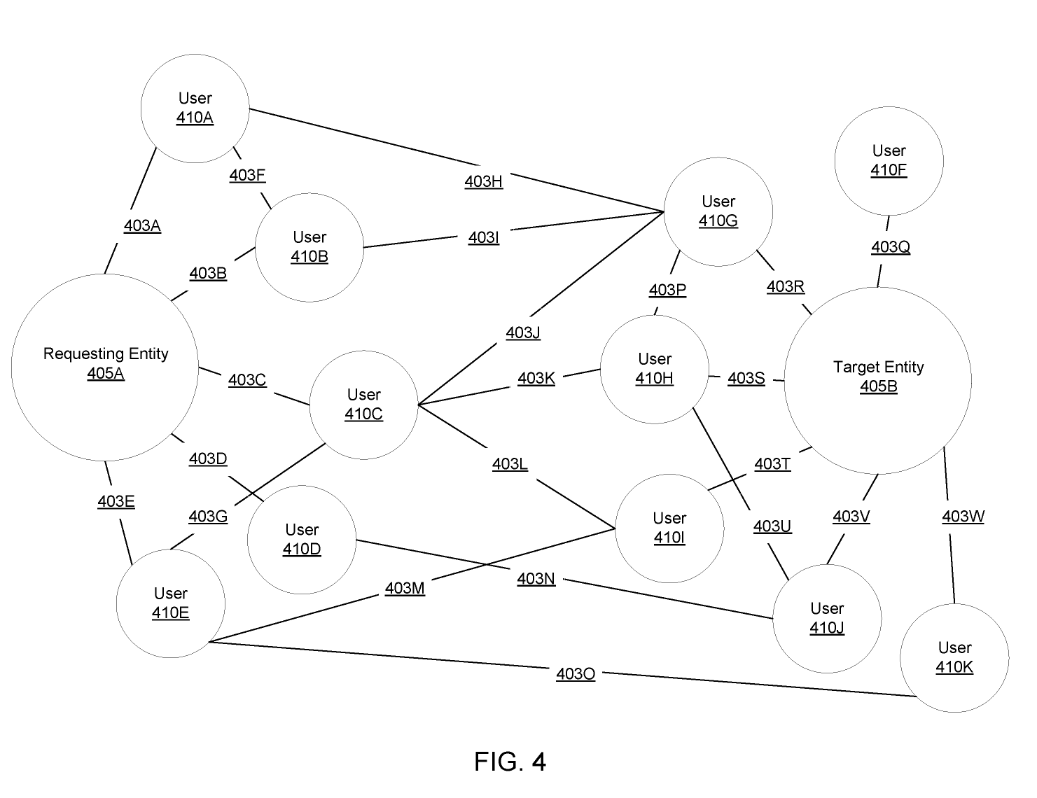

In the example of FIG. 4, the social graph includes a node corresponding to the requesting entity 405A, a node corresponding to the target entity 405B, nodes corresponding to users 410A-E associated with the requesting entity 405A, and nodes corresponding to users 410F-K associated with the target entity 405B. The social graph also may include edges 403 connecting the nodes that correspond to connections 403 between the entities 405 and users 410. Once the network module 240 has identified a user (e.g., User 410A) associated with the requesting entity 405A, the network module 240 may retrieve information from the edge store 225 describing one or more connections (e.g., connection 403L) between the user (e.g., User 410A) and one or more users (e.g., User 410G) associated with the target entity 405B. The network module 240 may then determine whether additional connections 403 exist between additional users (e.g., Users 410B-E) associated with the requesting entity 405A and users (e.g., Users 410F-K) associated with the target entity 405B.

The network module 240 may identify characteristics of each connection 403 between a user 410A-E associated with the requesting entity 405A and a user 410F-K associated with the target entity 405B. In some embodiments, characteristics of connections that the network module 240 may identify include the degrees of separation between a user 410A-E associated with the requesting entity 405A and a user 410F-K associated with the target entity 405B. The degrees of separation between the users may be equal to the number of edges required to connect the nodes corresponding to the users 410 in the social graph. For example, since one edge corresponding to connection 403H separates User 410A and User 410G, one degree of separation separates them. As an additional example, since two edges corresponding to connections 403G and 403K separate User 410E and User 410H, two degrees of separation separate them. In some embodiments, the network module 240 also may identify multiple connections that exist between a user 410A-E associated with the requesting entity 405A and a user 410F-K associated with the target entity 405B. For example, User 410A and User 410G are connected directly by connection 403H and indirectly by connections 403F and 4031.

Referring back to FIG. 3, once the online system 140 has identified 310 connections between users associated with the requesting entity and users associated with the target entity, the online system 140 may retrieve 315 (e.g., via the network module 240) information describing the connections. For example, the network module 240 may retrieve 315 information describing the number of connections between a user associated with the requesting entity and a user associated with the target entity. Additionally, in this example, the network module 240 may retrieve 315 information describing the degrees of separation that separate the users.

The network module 240 also may retrieve 315 information stored in association with the connections between the users associated with the requesting entity and the users associated with the target entity. For example, the network module 240 may retrieve 315 information describing the duration of a connection and information describing a type of connection between users, such as business relationships (e.g., co-workers and client-agency relationships). Information stored in association with a connection between users also may describe types of personal relationships between the users (e.g., friendships and familial relationships), transactions between the users (e.g., content shared by the users, messages exchanged between the users, a number/dollar amount of business transactions between the users, etc.), and any other suitable types of information describing a connection between the users.

The online system 140 assigns 320 (e.g., via the trust manager 245) a level of trust between the requesting entity and the target entity. The level of trust may be assigned 320 by the trust manager 245 based at least in part on the connections maintained by the online system 140 between the first set of users associated with the requesting entity and the second set of users associated with the target entity that are identified 310 by the network module 240. In some embodiments, the trust manager 245 assigns 320 the level of trust based at least in part on the number of connections between the users associated with the requesting entity and the users associated with the target entity. For example, the trust manager 245 may assign 320 the level of trust between the requesting entity and the target entity based on an assumption that the greater the number of connections between the users associated with the requesting entity and the users associated with the target entity, the greater the level of trust between the requesting entity and the target entity. In this example, the level of trust assigned 320 by the trust manager 245 between the requesting entity and the target entity is proportional to the number of connections between users associated with the requesting entity and the users associated with the target entity.

The trust manager 245 also may assign 320 the level of trust between the requesting entity and the target entity based on the degrees of separation between the users associated with the requesting entity and the users associated with the target entity to which the users associated with the requesting entity are connected. For example, the trust manager 245 may assign the level of trust between the requesting entity and the target entity based on an assumption that the degrees of separation between users associated with the requesting entity and the users associated with the target entity are indicative of the level of trust between the entities. In this example, the degrees of separation between the users associated with the requesting entity and the users associated with the target entity may be inversely proportional to the level of trust that that is assigned 320 between the two entities. In embodiments in which multiple connections may exist between a user associated with the requesting entity and a user associated with the target entity, the degrees of separation between the users may be equal to the degrees of separation corresponding to the shortest path connecting the nodes representing the users in a social graph maintained by the online system 140.

In various embodiments, the level of trust between the requesting entity and the target entity may be assigned 320 based on information stored in association with the connections between the users associated with the requesting entity and the users associated with the target entity. For example, the information stored in association with a connection between a user associated with the requesting entity and a user associated with the target entity may indicate different types of relationships between the users who are connected (e.g., work relationships, friendships, familial relationships, etc.), a duration of a connection between the users, information describing interactions between the users, etc. In this example, the trust manager 245 may assign 320 the level of trust between the requesting entity and the target entity based on weights that are associated with the information stored in association with connections between the users associated with the requesting entity and the users associated with the target entity. For example, different weights may be associated with different types of relationships. Additionally, weights may be proportional to the duration of the connections or to the frequency with which messages are sent between the users. For example, a connection between users that has been established for 20 years may be weighted less heavily than an additional connection between users that has been established for two years if the users in the former connection have not interacted in the online system 140 within the previous two years, but the users in the latter connection have frequently interacted in the online system 140 within the previous two years.

In some embodiments, each of multiple connections between the same users associated with the requesting entity and the target entity is used to assign 320 the level of trust between the entities. For example, if a direct connection and three indirect connections exist between an employee of the requesting entity and an employee of the target entity, each connection is used to assign 320 the level of trust between the requesting entity and the target entity. In other embodiments, if multiple connections exist between the same users associated with the requesting entity and the target entity, only a subset of the connections may be used to assign 320 the level of trust between the entities. For example, only the connection with the fewest degrees of separation between the same employees of the requesting entity and the target entity (e.g., the direct connection in the previous example) may be used to assign 320 the level of trust between the requesting entity and the target entity.

In some embodiments, the trust manager 245 may assign 320 the level of trust between the requesting entity and the target entity absent receiving 305 a request from the requesting entity to perform an action directed towards the target entity. For example, the trust manager 245 may periodically update the level of trust assigned 320 between the requesting entity and the target entity or in response to receiving a request to establish, delete, or modify a connection between a user associated with the requesting entity and a user associated with the target entity. In this example, the updated level of trust may be stored in association with the connection between the entities for subsequent retrieval (e.g., by the permission manager 250).

In some embodiments, the level of trust assigned 320 between the requesting entity and the target entity may be stored 325 in association with a connection between the requesting entity and the target entity. For example, in a social graph maintained by the online system 140 that is stored in the edge store 225, the level of trust assigned between the requesting entity and the target entity may be stored 325 in association with an edge connecting a node representing the requesting entity and a node representing the target entity.

The online system 140 determines 330 (e.g., via the permission manager 250) whether to grant or deny the requesting entity permission to perform the requested action. In some embodiments, the permission manager 250 determines 330 whether to grant or deny the requesting entity's request by determining whether the assigned level of trust between the requesting entity and the target entity exceeds a threshold level of trust associated with the requested action (e.g., retrieved from the permission store 260). If the assigned level of trust exceeds the threshold level of trust, the permission manager 250 may determine 330 that the requesting entity should be permitted to perform the action directed towards the target entity; otherwise, the permission manager 250 may determine 330 that the request should be denied. For example, if the assigned 320 level of trust between the entities does not exceed a threshold level of trust, the permission manager 250 may determine 330 that the requesting entity should not be permitted to initiate a message to the target entity via the online system 140 if the message comprises an advertisement or other types of spam, but should be permitted to initiate other types of messages to the target entity that comply with the policies of the online system 140.

In various embodiments, the permission manager 250 may determine 330 whether to grant or deny permission to the requesting entity to perform an action directed towards the target entity by determining a set of actions permitted between the requesting entity and the target entity corresponding to the level of trust assigned between the entities and by comparing the set of permitted actions to the requested action. For example, the permission manager 250 may determine that a certain level of trust between the requesting entity and the target entity corresponds to permitting the requesting entity to indicate a preference for content posted by the target entity and to share content with the target entity that does not include advertisements or other types of spam. In this example, the permission manager 250 may determine that an even higher level of trust between the requesting entity and the target entity corresponds to permitting the requesting entity to indicate a preference for content posted by the target entity and to share any type of content with the target entity. In the above examples, by comparing the action requested by the requesting entity to the permitted set of actions, the permission manager 250 may determine 330 that the requesting entity is permitted to share an advertisement with the target entity if the level of trust between the entities is at least the higher level of trust.

In some embodiments, the permission manager 250 also or alternatively may determine a set of actions restricted between the entities corresponding to the level of trust assigned between the entities. Information describing the permitted or restricted actions corresponding to a level of trust assigned between two entities may be stored (e.g., in the permission store 260 and/or in association with one or more connections between the entities in the edge store 225). Additionally, the set of actions permitted between the requesting entity and the target entity corresponding to the level of trust assigned 320 between the entities may be reciprocal, such that the set of actions the requesting entity is permitted/restricted from performing that are directed towards the target entity are the same set of actions the target entity is permitted/restricted from performing that are directed towards the requesting entity.

Once the permission manager 250 has determined 330 whether to grant or deny permission to the requesting entity to perform an action directed towards the target entity based on the level of trust between the requesting entity and the target entity, the online system 140 permits 335 or denies 340 (e.g., via the permission manager 250) the request accordingly. In response to the assigned level of trust between the requesting entity and the target entity exceeding a threshold level of trust, the permission manager 250 permits 335 the requesting entity to perform the action directed towards the target entity. For example, if the requesting entity has requested to send a message to the target entity, the permission manager 250 may communicate the message to the target entity upon determining 330 that the request should be granted. In response to the assigned level of trust between the requesting entity and the target entity failing to exceed a threshold level of trust, the permission manager 250 denies 340 the request from the requesting entity to perform the action directed towards the target entity. In the previous example, the permission manager 250 may block the message from being sent from the requesting entity to the target entity upon determining 330 that the request should not be granted.

In some embodiments, the online system 140 generates (e.g., via the user interface module 265) a notification sent to the requesting entity notifying the requesting entity whether their request to perform an action in the online system 140 was granted or denied. In some embodiments, the notification is generated by the user interface module 265 in response to receiving a request from the requesting entity to perform an action directed towards the target entity. For example, if the permission manager 250 has determined 330 that the requesting entity's request to perform an action directed towards the target entity should be granted, the user interface module 265 may generate a notification that is sent to the requesting entity that indicates that their request has been granted. In this example, the notification optionally may include elements facilitating the ability of the requesting entity to perform the action directed towards the target entity (e.g., an input field configured to receive text that may be included in a message the requesting entity is requesting to send to the target entity). As an additional example, if the permission manager 250 has determined 330 that the requesting entity's request to perform an action directed towards the target entity should not be granted, the user interface module 265 may generate a notification that is sent to the requesting entity that indicates that their request has been denied. In this example, the notification optionally may include an explanation as to why the request was denied (e.g., the requesting entity attempted to send spam to the target entity).

### Determining Whether to Allocate Credit to a User for Advertising Services

FIG. 5 is a flow chart of a method for determining whether to permit a requesting entity of an online system to create an advertising account associated with a user profile associated with the requesting entity, according to one embodiment. In other embodiments, the method may include different and/or additional steps than those shown in FIG. 5. Additionally, steps of the method may be performed in a different order than the order described in conjunction with FIG. 5.

Once a level of trust has been assigned 320 by the trust manager 245 between the requesting entity and the target entity, the online system 140 may receive 505 a request from the requesting entity to create an advertising account associated with a user profile of the requesting entity. The advertising account, if created, is associated with an amount of credit extended to the requesting entity for purchasing advertising services provided by the online system 140. The amount of credit may be a default amount (e.g., an amount associated with all newly-created advertising accounts), an amount specified by the requesting entity (e.g., included in the request received from the requesting entity), or an amount to be determined by the ad account manager 255. In various embodiments, the requesting entity may specify a number of advertising accounts in their request to create the advertising account(s). In addition or alternatively, in some embodiments, the request received from the requesting entity is a request to allocate an amount of credit to an advertising account associated with the requesting entity (e.g., an existing advertising account).

In some embodiments, the online system 140 determines 510 (e.g., via the trust manager 245) a level of trustworthiness associated with a target entity based on historical information associated with the target entity indicating a level of credit-worthiness. For example, the trust manager 245 determines 510 a level of trustworthiness associated with the target entity based on the number of advertising accounts the target entity has with the online system 140, whether the target entity actively uses the accounts, an average amount the target entity spends each year on advertising services provided by the online system 140, and whether the target entity has ever defaulted on a payment to the online system 140 in exchange for advertising services.

In some embodiments, the target entity is included in a trusted network if the target entity is associated with at least a threshold level of trustworthiness. The trust manager 245 may identify entities and other users of a trusted network based on historical information associated with each of the trusted entities/users indicating at least a threshold measure of credit-worthiness (e.g., information stored in the ad account store 235 and/or user profile store 205). For example, an advertiser or advertising agency is considered a trusted entity if it has at least three advertising accounts with the online system 140, actively uses the accounts every month, has spent at least $10,000 on advertising each year for at least the previous eight years, and the advertiser or advertising agency has never defaulted on a payment to the online system 140 in exchange for advertising services during those eight years. In some embodiments, the historical information used to identify entities of the trusted network may correspond to a frequency or seasonality of advertisement purchases made by the entities. For example, if an entity primarily purchases advertisements for skis, rather than using a total amount spent by the entity to determine the credit-worthiness of the entity, the trust manager 245 determines the credit-worthiness of the entity based on the entity's average monthly advertisement purchases during months in the winter and late fall.

In some embodiments, when identifying entities of the trusted network, the trust manager 245 discounts historical spending information associated with the entities by an amount that the online system 140 has not yet collected or by an amount charged by the online system 140 that may be subject to reversal (e.g., chargeback of a disputed amount). For example, an entity is included in the trusted network if the total amount the entity spent on advertising in the previous year, when adjusted by any pending payments towards the total amount, is at least a threshold amount. The trust manager 245 may identify amounts not yet collected by the online system 140 and/or amounts that may be subject to reversal based on geographic information associated with entities and/or payment information provided by the entities. For example, different policies may apply to entities located in different geographic locations, such that the timeframe within which a charge may be disputed may vary for different entities based on their geographic location. As an additional example, recent payments made by credit cards may be subject to reversal while older payments made by credit cards and by withdrawals from a bank account are less likely to be subject to reversal.

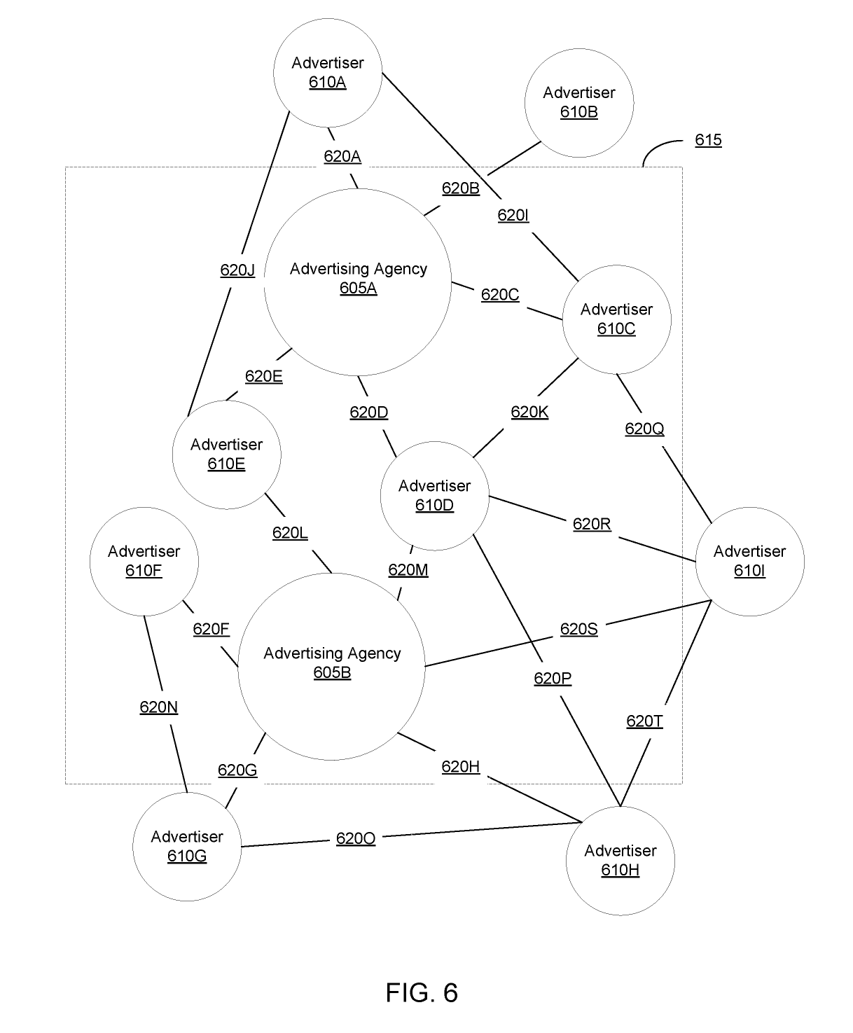

The trust manager 245 may identify entities of the trusted network based on information stored in the edge store 225 indicating connections between the entities. In the example of FIG. 6, a social graph maintained by the online system 140 includes nodes corresponding to entities of a trusted network of entities (e.g., Advertising Agencies 605A-605B and Advertisers 610C-610F). The social graph also includes nodes corresponding to additional entities (Advertisers 610A-610B and Advertisers 610G-6101) that are not included in the trusted network, where a boundary 615 separates the groups of entities. The social graph also may include edges 620 that connect the nodes that each corresponds to a connection between two or more entities. Once the trust manager 245 has identified a trusted entity or user of the online system 140, the network module 240 may retrieve information from the edge store 225 describing connections between the trusted entity and additional entities/users of the online system 140. The trust manager 245 may then determine whether each additional entity/user to which the trusted entity/user is connected is also a trusted entity/user. Additional entities/users connected to the trusted entity/user who are determined to be trusted entities/users are also identified as part of the trusted network while additional entities/users connected to the trusted entity/user who are not determined to be trusted entities/users are not identified as part of the trusted network.

Alternatively, the target entity may be included in an untrusted network if the target entity is associated with less than a threshold level of trustworthiness. The trust manager 245 may identify entities and other users of the untrusted network based on similar types of information used to identify entities and other users of the trusted network. In one embodiment, the trust manager 245 may identify entities/users of the untrusted network based on information indicating that the entities/users are associated with less than a threshold measure of credit-worthiness. For example, an advertiser or advertising agency is considered an untrusted entity if it has fewer than two advertising accounts with the online system 140 and does not actively use the accounts every month, or has defaulted on a payment to the online system 140 for at least 10% of their spending on advertising services during any of the previous eight years.

Referring back to FIG. 5, in some embodiments, the level of trustworthiness associated with the target entity is stored 515 by the online system 140. For example, the level of trustworthiness associated with the target entity may be stored 515 in the ad account store 235 in association with a user profile of the target entity and a date that the level of trustworthiness was determined 510. In some embodiments, only the most current level of trustworthiness is stored 515 for the requesting entity (e.g., by updating the previous level of trustworthiness with a new one) while in other embodiments, all levels of trustworthiness determined 510 for the target entity are stored (e.g., in a growing log of historical levels of trustworthiness).

The online system 140 may determine 520 (e.g., via the ad account manager 255) whether to grant or deny permission to the requesting entity to create the advertising account associated with the user profile of the requesting entity based on the level of trust assigned 320 between the requesting entity and the target entity and the level of trustworthiness determined 510 for the target entity. The online system 140 creates 525 (e.g., via the ad account manager 255) the requested advertising account associated with the user profile of the requesting entity in response to the level of trust assigned 320 between the requesting entity and the target entity exceeding a threshold level of trust and the level of trustworthiness determined 510 for the target entity exceeding a threshold level of trustworthiness. The ad account manager 255 creates 525 the requested advertising account by allocating the new advertising account to the requesting entity, such that the account is associated with the requesting entity's user profile. In embodiments in which the request received 505 from the requesting entity is a request to allocate an amount of credit to an advertising account associated with the requesting entity, the ad account manager 255 may allocate the requested amount of credit to the advertising account in response to the level of trust assigned 320 between the requesting entity and the target entity exceeding the threshold level of trust and the level of trustworthiness determined 510 for the target entity exceeding the threshold level of trustworthiness. Alternatively, in response to the level of trust assigned 320 between the requesting entity and the target entity failing to exceed the threshold level of trust and/or the level of trustworthiness determined 510 for the target entity failing to exceed the threshold level of trustworthiness, the online system 140 denies (e.g., via the ad account manager 255) the requesting entity's request and does not create 530 the advertising account or allocate the amount of credit to an advertising account associated with the requesting entity.

In embodiments in which the online system 140 allows the requesting entity to request to create multiple advertising accounts, the ad account manager 255 may determine 520 whether to grant or deny permission to the requesting entity to create the accounts. For example, the ad account manager 255 may determine 520 whether to allocate the requested number of advertising accounts to the requesting entity based on the level of trust assigned 320 between the requesting entity and the target entity and/or the level of trustworthiness determined 510 for the target entity. In this example, the number of advertising accounts that may be allocated to the requesting entity is proportional to the level of trust assigned 320 between the requesting entity and the target entity and/or the level of trustworthiness determined 510 for the target entity.

If the ad account manager 255 determines 520 that the requesting entity's request to create a specified number of advertising accounts should not be granted, the ad account manager 255 may deny the request, but offer to allow the requesting entity to create fewer advertising accounts. For example, information retrieved from the permission store 260 may describe different ranges of levels of trust assigned 320 between the requesting entity and the target entity and/or different ranges of levels of trustworthiness determined 510 for the target entity that are associated with different numbers of advertising accounts such that the number of advertising accounts is proportional to the ranges of levels of trustworthiness and/or the different ranges of levels of trustworthiness. In this example, if the level of trust assigned 320 between the requesting entity and the target entity is less than a threshold level of trust and/or the level of trustworthiness determined 510 for the target entity is less than a threshold measure of trustworthiness required for the ad account manager 255 to create the number of advertising accounts being requested, the ad account manager 255 may deny the request. The ad account manager 255 in this example may offer to allow the requesting entity to create a smaller number of advertising accounts for which the level of trust assigned 320 between the requesting entity and the target entity and the level of trustworthiness determined 510 for the target entity qualify.

In embodiments in which the ad account manager 255 creates 525 a new advertising account associated with the user profile of the requesting entity, the ad account manager 255 also may determine an amount of credit to allocate to the new advertising account. The amount of credit allocated to a new advertising account may be a default amount. For example, every new advertising account may be associated with a default of $2,000 in credit. Alternatively, the amount of credit allocated to a new advertising account may be specified by the requesting entity (e.g., in the request received from the requesting entity) and automatically allocated to the advertising account upon approval of the request by the ad account manager 255. As another alternative, the amount of credit allocated to a new advertising account may be determined by the ad account manager 255. For example, the amount of credit allocated to an advertising account is proportional to the level of trust assigned 320 between the requesting entity and the target entity and/or the level of trustworthiness determined 510 for the target entity.

In embodiments in which the requesting entity is permitted to create multiple advertising accounts, the number of advertising accounts that may be allocated to the requesting entity may be inversely proportional to the amount of credit allocated to each advertising account. For example, the ad account manager 255 may allocate various numbers of advertising accounts to the requesting entity, as long as the total amount of credit allocated to the requesting entity is equal to or less than a maximum amount. In this example, the ad account manager 255 may allocate one advertising account to the requesting entity that is allocated $1,000 in credit, two advertising accounts that each are allocated $500 in credit, three advertising accounts that each are allocated $333 in credit, etc.

Additionally or alternatively, if the requesting entity has requested that the online system 140 allocate an amount of credit to an advertising account associated with their user profile (e.g., a newly-created advertising account or an existing advertising account), the ad account manager 255 may determine 520 whether to grant or deny the request based on the level of trust assigned 320 between the requesting entity and the target entity and the level of trustworthiness determined 510 for the target entity. For example, different amounts of credit may be associated with different ranges of levels of trust assigned 320 between the requesting entity and the target entity and/or different levels of trustworthiness determined 510 for the target entity. In this example, the greater the amount of credit being requested by the requesting entity, the higher the level of trust between the requesting entity and the target entity and/or the higher the level of trustworthiness associated with the target entity required in order for the ad account manager 255 to grant the request. If the ad account manager 255 determines 520 that the requesting entity's request for an amount of credit should not be granted, the ad account manager 255 may deny the request, but offer a lesser amount of credit to allocate to the requesting entity.

In some embodiments, the ad account manager 255 also may determine whether to manually review advertisement requests received from the requesting entity based on the level of trust assigned 320 between the requesting entity and the target entity and the level of trustworthiness determined 510 for the target entity. For example, if the level of trust assigned 320 between the requesting entity and the target entity and the level of trustworthiness determined 510 for the target entity are within certain ranges of levels, the ad account manager 255 may permit the requesting entity to create a new advertising account and allocate a specified amount of credit to the account, but may require advertisement requests received from the requesting entity to be manually reviewed for compliance with advertising policies before presenting them to users of the online system 140.

In some embodiments, the online system 140 generates (e.g., via the user interface module 265) a notification that is sent to the requesting entity notifying them if the advertising account was created. The notification also may or alternatively notify the requesting entity whether their request to allocate an amount of credit to an advertising account associated with their user profile was granted or denied. For example, if the level of trust assigned 320 between the requesting entity and the target entity exceeds a threshold level of trust and the level of trustworthiness determined 510 for the target entity exceeds a threshold level of trustworthiness, the user interface module 265 may generate a notification for the requesting entity that indicates that their request has been granted and specifies a number of advertising accounts allocated to the requesting entity, an amount of credit allocated to each of the allocated accounts, etc. As an additional example, if the level of trust assigned 320 between the requesting entity and the target entity fails to exceed a threshold level of trust and/or the level of trustworthiness determined 510 for the target entity fails to exceed a threshold level of trustworthiness, the user interface module 265 may generate a notification for the requesting entity that indicates that their request has been denied and includes details about why the request was denied (e.g., a maximum number of advertising accounts associated with their user profile has been reached, a number of previous payments on which the requesting entity has defaulted, etc.).

In some embodiments, the notification may permit the requesting entity to provide one or more inputs related to the notification. For example, if the requesting entity has requested to create at least one advertising account, the notification may inform the requesting entity that they are permitted to create up to a maximum number of advertising accounts, in which the maximum number of advertising accounts is proportional to the level of trust assigned 320 between the requesting entity and the target entity and/or the level of trustworthiness determined 510 for the target entity. In this example, the notification may include an input area that allows the requesting entity to specify a number of advertising accounts to allocate. As an additional example, the notification may include an input area that allows the requesting entity to create a name associated with a newly created advertising account or to associate one or more advertisements or advertising campaigns with the advertising account.

The notification also may include one or more interactive elements that allow the requesting entity to compare multiple advertising accounts and credit options that may be allocated to the requesting entity. For example, if the notification informs the requesting entity that their request to create three advertising accounts has been granted and that a maximum amount of $3,000 in credit may be allocated to the accounts, the notification may include radio buttons, drop-down menus, slider bars, etc. that allow the requesting entity to select an amount of credit to allocate to each account. In this example, if the requesting entity specifies amounts of credit to allocate to two accounts, the amount of credit allocated to the other account is automatically adjusted so that the total amount allocated to all three accounts does not exceed $3,000. The notification may be sent to the requesting entity (e.g., in a display area of a client device 110 associated with the requesting entity).

In some embodiments, the trust manager 245 also may use the level of trust assigned between the requesting entity and the target entity and the level of trustworthiness associated with the target entity to determine whether to add the requesting entity to the trusted network. The requesting entity may be added to the trusted network based on the level of trust assigned 320 between the requesting entity and the target entity and the level of trustworthiness associated with the target entity, based on an effect of the level of trust assigned between the requesting entity and the target entity and the level of trustworthiness associated with the target entity, or based on some combination of attributes associated with the requesting entity. For example, the requesting entity may be added to the trusted network if the amount of credit allocated to the requesting entity is at least a threshold amount or the number of advertising accounts allocated to the requesting entity reaches a maximum number permitted by the online system 140. As an additional example, the requesting entity may be added to the trusted network if the level of trust assigned between the requesting entity and the target entity is at least a threshold level of trust, the level of trustworthiness associated with the target entity is at least a threshold level of trustworthiness, and the online system 140 has maintained an advertising account for the requesting entity for at least 10 years.

The trust manager 245 also may use the level of trust assigned between the requesting entity and the target entity and the level of trustworthiness associated with the target entity to determine whether to add the requesting entity to the untrusted network. For example, the requesting entity may be added to the untrusted network if the amount of credit allocated to the requesting entity is at least a threshold amount and the requesting entity has defaulted on a payment for advertising services provided by the online system 140 within the last three years. As an additional example, the requesting entity may be added to the untrusted network if the level of trust assigned between the requesting entity and the target entity is at least a threshold level of trust, the level of trustworthiness associated with the target entity is less than a threshold level of trustworthiness, and the online system 140 has not maintained an advertising account for the requesting entity for at least 10 years.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a request from a requesting entity of an online system to perform an action directed towards a target entity of the online system, wherein the requesting entity is associated with a first set of users of the online system and the target entity is associated with a second set of users of the online system;
identifying connections maintained by the online system between users of the first set of users of the online system associated with the requesting entity and users of the second set of users of the online system associated with the target entity;
assigning a level of trust between the requesting entity and the target entity based at least in part on the identified connections maintained by the online system between the first set of users of the online system associated with the requesting entity and the second set of users of the online system associated with the target entity; and
in response to the assigned level of trust between the requesting entity and the target entity exceeding a threshold level of trust, permitting the requesting entity to perform the action directed towards the target entity of the online system.

2. The method of claim 1, wherein the action directed towards the target entity comprises communicating a message to the target entity.

3. The method of claim 1, wherein assigning the level of trust between the requesting entity and the target entity comprises:
accessing a graph maintained by the online system, the graph comprising a plurality of nodes and one or more edges, wherein each node corresponds to an object maintained by the online system, and each edge corresponds to a connection between two or more objects;
for each of the first set of users of the online system associated with the requesting entity and each of the second set of users of the online system associated with the target entity:
identifying in the graph a first node corresponding to a user of the first set of users and a second node corresponding to a user of the second set of users;
determining a number of different paths connecting the first node and the second node, each path comprising at least the first node, the second node, and an edge; and
determining a number of edges required to connect the first node and the second node; and
assigning the level of trust between the requesting entity and the target entity based at least in part on the number of different paths connecting the first node and the second node and the number of edges required to connect the first node and the second node for each of the first set of users of the online system associated with the requesting entity and each of the second set of users of the online system associated with the target entity.

4. The method of claim 1, wherein assigning the level of trust between the requesting entity and the target entity comprises:
retrieving information stored in association with each of the connections maintained by the online system between users of the first set of users of the online system associated with the requesting entity and users of the second set of users of the online system associated with the target entity;
associating a weight with each of the connections maintained by the online system between users of the first set of users of the online system associated with the requesting entity and users of the second set of users of the online system associated with the target entity based at least in part on the information stored in association with each of the connections; and
assigning the level of trust between the requesting entity and the target entity based at least in part on the weights.

5. The method of claim 4, wherein the information stored in association with each of the connections maintained by the online system between users of the first set of users of the online system associated with the requesting entity and users of the second set of users of the online system associated with the target entity is selected from a group consisting of: information indicating a type of relationship between each of the first set of users of the online system associated with the requesting entity and each of the second set of users of the online system associated with the target entity, an amount of time elapsed since the connection was established between each of the first set of users of the online system associated with the requesting entity and each of the second set of users of the online system associated with the target entity, one or more interactions between each of the first set of users of the online system associated with the requesting entity and each of the second set of users of the online system associated with the target entity, and any combination thereof.

6. The method of claim 1, further comprising:
retrieving historical spending information associated with advertising services provided by the online system to the target entity; and
determining a level of trustworthiness associated with the target entity based at least in part on the historical spending information associated with advertising services provided by the online system to the target entity.

7. The method of claim 6, wherein the historical spending information associated with advertising services provided by the online system to the target entity comprises one or more selected from a group consisting of: a number of advertising accounts associated with the target entity maintained by the online system, an amount of credit extended to the target entity for advertising services provided by the online system, a timeliness of one or more payments made by the target entity to the online system for advertising services provided by the online system, a frequency with which the target entity previously purchased advertising services provided by the online system, and any combination thereof.

8. The method of claim 6, further comprising:
receiving, from the requesting entity, a request to extend an amount of credit to the requesting entity for advertising services provided by the online system;
determining whether to extend the requested amount of credit to the requesting entity based at least in part on the assigned level of trust between the requesting entity and the target entity and the level of trustworthiness associated with the target entity; and
in response to the assigned level of trust between the requesting entity and the target entity exceeding the threshold level of trust and the level of trustworthiness associated with the target entity exceeding a threshold level of trustworthiness, allocating the requested amount of credit to the requesting entity.

9. The method of claim 6, wherein determining the level of trustworthiness associated with the target entity comprises:
determining a total amount spent by the target entity on advertising services provided by the online system during a specified period of time based at least in part on the historical spending information associated with advertising services provided by the online system to the target entity;
determining a subset of the total amount spent by the target entity on advertising services provided by the online system during the specified period of time that is subject to reversal;
determining a difference between the total amount spent by the target entity on advertising services provided by the online system and the subset of the total amount spent by the target entity on advertising services provided by the online system that is subject to reversal; and
determining the level of trustworthiness associated with the target entity based at least in part on the difference.

10. The method of claim 9, wherein determining a subset of the total amount spent by the target entity on advertising services provided by the online system that is subject to reversal is based at least in part on one or more selected from a group consisting of: a payment method used by the target entity to pay for the subset of the total amount spent by the target entity on advertising services provided by the online system, an amount of time elapsed since a payment was made for the subset of the total amount spent by the target entity on advertising services provided by the online system, a geographic location associated with the target entity, and any combination thereof.

11. The method of claim 1, further comprising:
determining whether the assigned level of trust between the requesting entity and the target entity exceeds the threshold level of trust.

12. The method of claim 1, further comprising:
storing the assigned level of trust between the requesting entity and the target entity in association with a connection between the requesting entity and the target entity.

13. The method of claim 1, further comprising:
in response to the assigned level of trust between the requesting entity and the target entity not exceeding the threshold level of trust, denying the requesting entity to perform the action directed towards the target entity of the online system.

14. A computer program product comprising a computer readable storage medium having instructions encoded thereon that, when executed by a processor, cause the processor to:
receive a request from a requesting entity of an online system to perform an action directed towards a target entity of the online system, wherein the requesting entity is associated with a first set of users of the online system and the target entity is associated with a second set of users of the online system;
identify connections maintained by the online system between users of the first set of users of the online system associated with the requesting entity and users of the second set of users of the online system associated with the target entity;
assign a level of trust between the requesting entity and the target entity based at least in part on the identified connections maintained by the online system between the first set of users of the online system associated with the requesting entity and the second set of users of the online system associated with the target entity; and
in response to the assigned level of trust between the requesting entity and the target entity exceeding a threshold level of trust, permit the requesting entity to perform the action directed towards the target entity of the online system.

15. The computer program product of claim 14, wherein the action directed towards the target entity comprises communicating a message to the target entity.

16. The computer program product of claim 14, wherein assign the level of trust between the requesting entity and the target entity comprises:
access a graph maintained by the online system, the graph comprising a plurality of nodes and one or more edges, wherein each node corresponds to an object maintained by the online system, and each edge corresponds to a connection between two or more objects;
for each of the first set of users of the online system associated with the requesting entity and each of the second set of users of the online system associated with the target entity:
identify in the graph a first node corresponding to a user of the first set of users and a second node corresponding to a user of the second set of users;
determine a number of different paths connecting the first node and the second node, each path comprising at least the first node, the second node, and an edge; and
determine a number of edges required to connect the first node and the second node; and
assign the level of trust between the requesting entity and the target entity based at least in part on the number of different paths connecting the first node and the second node and the number of edges required to connect the first node and the second node for each of the first set of users of the online system associated with the requesting entity and each of the second set of users of the online system associated with the target entity.

17. The computer program product of claim 14, wherein assign the level of trust between the requesting entity and the target entity comprises:
retrieve information stored in association with each of the connections maintained by the online system between users of the first set of users of the online system associated with the requesting entity and users of the second set of users of the online system associated with the target entity;
associate a weight with each of the connections maintained by the online system between users of the first set of users of the online system associated with the requesting entity and users of the second set of users of the online system associated with the target entity based at least in part on the information stored in association with each of the connections; and
assign the level of trust between the requesting entity and the target entity based at least in part on the weights.

18. The computer program product of claim 17, wherein the information stored in association with each of the connections maintained by the online system between users of the first set of users of the online system associated with the requesting entity and users of the second set of users of the online system associated with the target entity is selected from a group consisting of: information indicating a type of relationship between each of the first set of users of the online system associated with the requesting entity and each of the second set of users of the online system associated with the target entity, an amount of time elapsed since the connection was established between each of the first set of users of the online system associated with the requesting entity and each of the second set of users of the online system associated with the target entity, one or more interactions between each of the first set of users of the online system associated with the requesting entity and each of the second set of users of the online system associated with the target entity, and any combination thereof.

19. The computer program product of claim 14, wherein the computer readable storage medium further has instructions encoded thereon that, when executed by the processor, cause the processor to:
retrieve historical spending information associated with advertising services provided by the online system to the target entity; and
determine a level of trustworthiness associated with the target entity based at least in part on the historical spending information associated with advertising services provided by the online system to the target entity.

20. The computer program product of claim 19, wherein the historical spending information associated with advertising services provided by the online system to the target entity comprises one or more selected from a group consisting of: a number of advertising accounts associated with the target entity maintained by the online system, an amount of credit extended to the target entity for advertising services provided by the online system, a timeliness of one or more payments made by the target entity to the online system for advertising services provided by the online system, a frequency with which the target entity previously purchased advertising services provided by the online system, and any combination thereof.

21. The computer program product of claim 19, wherein the computer readable storage medium further has instructions encoded thereon that, when executed by the processor, cause the processor to:
receive, from the requesting entity, a request to extend an amount of credit to the requesting entity for advertising services provided by the online system;
determine whether to extend the requested amount of credit to the requesting entity based at least in part on the assigned level of trust between the requesting entity and the target entity and the level of trustworthiness associated with the target entity; and
in response to the assigned level of trust between the requesting entity and the target entity exceeding the threshold level of trust and the level of trustworthiness associated with the target entity exceeding a threshold level of trustworthiness, allocate the requested amount of credit to the requesting entity.

22. The computer program product of claim 19, wherein determine the level of trustworthiness associated with the target entity comprises:
determine a total amount spent by the target entity on advertising services provided by the online system during a specified period of time based at least in part on the historical spending information associated with advertising services provided by the online system to the target entity;
determine a subset of the total amount spent by the target entity on advertising services provided by the online system during the specified period of time that is subject to reversal;
determine a difference between the total amount spent by the target entity on advertising services provided by the online system and the subset of the total amount spent by the target entity on advertising services provided by the online system that is subject to reversal; and
determine the level of trustworthiness associated with the target entity based at least in part on the difference.

23. The computer program product of claim 22, wherein determining a subset of the total amount spent by the target entity on advertising services provided by the online system that is subject to reversal is based at least in part on one or more selected from a group consisting of: a payment method used by the target entity to pay for the subset of the total amount spent by the target entity on advertising services provided by the online system, an amount of time elapsed since a payment was made for the subset of the total amount spent by the target entity on advertising services provided by the online system, a geographic location associated with the target entity, and any combination thereof.

24. The computer program product of claim 14, wherein the computer readable storage medium further has instructions encoded thereon that, when executed by the processor, cause the processor to:
determine whether the assigned level of trust between the requesting entity and the target entity exceeds the threshold level of trust.

25. The computer program product of claim 14, wherein the computer readable storage medium further has instructions encoded thereon that, when executed by the processor, cause the processor to:
store the assigned level of trust between the requesting entity and the target entity in association with a connection between the requesting entity and the target entity.

26. The computer program product of claim 14, wherein the computer readable storage medium further has instructions encoded thereon that, when executed by the processor, cause the processor to:
in response to the assigned level of trust between the requesting entity and the target entity not exceeding the threshold level of trust, deny the requesting entity to perform the action directed towards the target entity of the online system.

27. A method comprising:
identifying connections maintained by an online system between users of a first set of users of the online system associated with a first entity and users of a second set of users of the online system associated with a second entity;
assigning a level of trust between the first entity and the second entity based at least in part on the identified connections maintained by the online system between the first set of users of the online system associated with the first entity and the second set of users of the online system associated with the second entity; and
determining a set of actions permitted between the first entity and the second entity based at least in part on the level of trust between the first entity and the second entity.
